(19) United States
(12) Patent Application Publication
(10) Pub. No.: US 2003/0228972 A1
(43) Pub. Date: Dec. 11, 2003

(54) OXYGEN REDUCTION CATALYST

(76) Inventors: Viola BIRSS, Calgary (CA); Aislinn SIRK, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/250,135

(22) Filed: Jun. 5, 2003

Related U.S. Application Data
(60) Provisional application No. 60/385,591, filed on Jun. 5, 2002.

(51) Int. Cl. B01J 31/00; C08F 4/02; C08F 4/60; B01J 37/00

(52) U.S. Cl. 502/124; 502/103

(57) ABSTRACT

A oxygen reduction catalyst includes a coordination complex of a transition metal and a nitrogen-carbon ligand. The catalyst may be formed by preparing a sol-gel with a metal salt such as a cobalt salt in an alcohol and adding the ligand slowly while refluxing. The catalyst may be adsorbed onto carbon powder and heat treated.

### CROSS REFERENCE TO RELATED APPLICATIONS

This application claims priority of U.S. Provisional Patent Application No. 60/385,591, filed on Jun. 5, 2002, the contents of which are incorporated herein by reference.

### BACKGROUND OF INVENTION

The present invention relates to a novel oxygen reduction catalyst for use in a fuel cell and methods for producing the oxygen reduction catalyst.

Platinum and other noble metals are effective catalysts for the reduction of oxygen in the air electrode of a fuel cell. However, because of the cost of noble metals, and platinum in particular, an effective non-noble metal catalyst may reduce the cost of fuel cell manufacture.

One group of materials that has been studied extensively in the past includes cobalt porphyrin derived materials which contain a CoN₄ unit and various carbon ring backbones. Dimeric species of the central CoN₄ unit are believed to be the active catalytic site. Iron porphyrin derived materials are also known to be effect oxygen reduction catalysts. It has been found that heat treatment under an inert atmosphere and the resulting partial decomposition of the structure leads to increased oxygen reduction reaction (ORR) activity and stability. Based on these results, there have been attempts to prepare materials that do not use the expensive porphyrin type starting material, but instead, prepare the Co—N—C materials directly. One approach has been to sputter-coat Co and C in a nitrogen atmosphere to produce an amorphous Co/N/C film (C. Deng, and M. Digman, Journal of the Electrochemical Society, 145 (1998) 3507). Sputter coated amorphous Co/N/C catalysts show reasonable activity under alkaline conditions but are unstable and inactive under acidic conditions. Therefore, they are unsuitable for use in proton exchange membrane fuel cells. Another approach utilizes the heating of manganese, iron or cobalt salts supported on carbon powder under acetonitrile and nitrogen gas (R. Cote, G. Lalande, G. Faubert, D. Guay, J. Dodelet and G Denes, Journal of New Materials for Electrochemical Systems, 1 (1998) 7). The cobalt catalysts produced showed little activity.

Therefore, there is a need in the art for non-noble metal catalysts effective in increasing ORR activity and suitable for use in a fuel cell.

### SUMMARY OF INVENTION

The present invention is directed to a non-noble metal fuel cell catalyst for oxygen reduction reactions (ORR) and methods of producing such catalysts. The invention may comprise catalysts based on transition metals such as cobalt, iron, nickel, vanadium, manganese and chromium. In one aspect and in general terms, the catalyst comprises an amorphous metal-nitrogen-carbon compound which is a coordination complex of a metal atom or ion and a nitrogen-carbon ligand. The catalyst may be produced by first preparing a metal oxide sol-gel and reacting the sol-gel with the nitrogen-carbon ligand. In a preferred embodiment, the transition metal comprises cobalt and the metal sol-gel is therefore a cobalt oxide sol-gel (CSG). In another embodiment, the transition metal comprises iron.

The CSG or other metal oxide sol-gels are produced using well-known methods of sol-gel chemistry. In one embodiment, the methods described in U.S. Pat. No. 4,959,247, Sept. 25, 1990 (Meaner et al., Electrochromic Coating and Method for Making Same), the contents of which are incorporated herein by reference, are preferred for producing the CSG. Methods of preparing sol-gels with other transition metals are described in this patent and are also well-known to those skilled in the art.

Therefore, in one aspect, the invention comprises a method of forming a catalyst comprising the step of reacting a transition metal with a nitrogen-carbon ligand. The transition metal is preferably a metal ion in solution or in a sol-gel. Preferably, the transition metal comprises cobalt or iron and the nitrogen-carbon ligand comprises a N—(C)ₓ—N portion wherein x is 1, 2 or 3. Preferably, the liquid comprises N—C—C—N and may include ethylene diamine, also known as 1,2 ethane diamine, or 1,2 phenylene diamine, also known as ortho-benzene diamine.

In an alternative embodiment, the catalyst is formed by providing an aqueous solution of cobalt and adding a nitrogen-carbon ligand. The: resulting solution is then evaporated to a gel, which may then be used directly as a catalyst or redissolved in water.

In a further alternative embodiment, the catalyst is formed by reacting a transition metal salt and a nitrogen-carbon ligand with sodium ethoxide in an alcohol. Preferably, the salt comprises cis- or trans-Co(R)₂Cl₂ where R is ethylene diamine or cis-Co(R)₂Cl₂ where R is 1, 2 phenylene diamine.

### BRIEF DESCRIPTION OF DRAWINGS

Embodiments of the invention will be described with reference to the following figures, in which:

FIG. 1 is a graph showing oxygen reduction catalytic activity at various sulphuric acid solution temperatures.

FIG. 2A is a graph showing oxygen reduction catalytic activity of various catalysts which have not been heat-treated. FIG. 2B is a graph showing oxygen reduction catalytic activity of the same catalysts after heat-treatment.

FIG. 3A is a graph showing oxygen reduction catalytic activity of an ethylene diamine catalyst after heat treatment at different temperatures. FIG. 3B is a graph showing oxygen reduction catalytic activity of a phenylene diamine catalyst after heat treatment at different temperatures.

FIG. 4 is a graph showing oxygen reduction catalytic activity of phenylene diamine catalysts with varying molar ratios of ligand to metal.

FIG. 5A is a graph showing oxygen reduction catalytic activity of various loading percentages, up to 25%. FIG. 5B is a graph showing oxygen reduction catalytic activity of various loading percentages from 25% to 50%.

### DETAILED DESCRIPTION

The present invention provides novel non-noble metal catalysts suitable for use in the cathode of a proton exchange membrane (PEM) fuel cell and methods for producing them. When describing the present invention, all terms not defined herein have their common art-recognized meanings.

The term “transition metal” means the metal elements of Groups 3 through 12 of the periodic table. Transition metals have valence electrons in more than one shell. Preferred transition metals include cobalt, iron, nickel, vanadium, manganese and chromium, but may also include ruthenium, rhodium, iridium, osmium, rhenium, molybdenum, or tungsten. Different transition metals may be combined with effective results, such as Co—Fe mixtures.

The term “nitrogen-carbon ligand” shall mean a molecule containing carbon and nitrogen and capable of binding to the transition metal atom preferably through a nitrogen atom. Preferred nitrogen-carbon ligands include a N—(C)ₓ—N configuration wherein x is 1, 2 or 3. Particularly preferred nitrogen carbon ligands include a N—C—C—N (where x is 2) and may include ethylene diamine (NH₂(CH₂)₂NH₂) or 1, 2 phenylene diamine, also known as ortho-benzenediamine (C₆H₈N₂). It is preferred, but not essential, that nitrogen-carbon ligands of the present invention be soluble in alcohols such as methanol, ethanol or propanol.

The term “ligand” shall mean an ion or molecule that donates a pair of electrons to a metal atom or ion in forming a coordination complex. Molecules that function as ligands act as Lewis bases. A “coordination complex” is a collection of species held together by coordinate bonding, where one of the two atoms bonded supplies both shared electrons.

In one embodiment, a metal oxide sol-gel is produced using the general methods described in U.S. Pat. No. 4,959,247, the contents of which are incorporated herein by reference. In one embodiment, the metal oxide sol-gel is a cobalt sol-gel. A cobalt salt such as cobalt nitrate or cobalt chloride is dissolved in an alcohol and may be, in a preferred embodiment, refluxed for a period of time. The alcohol used to form the cobalt salt solution is preferably a monoalcohol having from 1 to 5 carbon atoms. More preferred alcohols have from 1 to 3 carbon atoms and therefore include methanol, ethanol, propanol, isopropanol and mixtures thereof. Butyl and pentyl alcohols are broadly operable, but the cobalt salt may not be as soluble in the higher alcohols as in the lower alcohols. In some cases, solubility of the cobalt salt may be enhanced by using mixtures of alcohols. Preferably, the cobalt salt is hydrated and is slowly added to the alcohol. Reflux of the alcohol may enhance solubility but is not be a required step. The concentration of cobalt to alcohol may be varied by one skilled in the art.

Ethyl acetate or a non-ionic surfactant or wetting agent, or both ethyl acetate and a surfactant, may be added to the solution to improve the coating or adsorbing characteristics of the catalyst following addition of the nitrogen-carbon ligand.

In one embodiment, hydrated Co(NO₃)₂ is dissolved in ethanol and refluxed for a period of time, preferably between about 2 to 6 hours, and then stirred at room temperature for an additional period of time, preferably about 6 to 24 hours. The solution is then refluxed again and a nitrogen-carbon ligand, preferably diluted 1/10 (v:v) in 1:1 ethanol:ethyl acetate (v:v) is added to the solution. The dilute ligand may be added slowly, preferably drop wise, over a period of time, with constant stirring of the solution during reflux. The ratio of total ligand added to the Co oxide sol-gel may preferably range from 1 to about 4 molar equivalents, and more preferably range from about 2 to about 3 molar equivalents of ligand to cobalt.

The ligand preferably incorporates a N—C—N, N—C—C—N, or a N—C—C—C—N portion, where the dashes represent bonds between the nitrogen and carbon atoms, which may include single or double bonds. Preferred ligands include the diamines identified herein as well as ligands such as difluoro-1,2 phenylene diamine, trifluoro-1,2 phenylene diamine, ethene-1,2-diamine, butane-2,3 diamine, and 2,3-diamino-succinic acid, among others. Catalysts may be prepared using mixtures of different ligands. The preferred range of ligand to metal ratio is also from about 1.5 to about 4 and more preferably about 2 on a molar basis.

The resulting sol-gel derived catalyst may be used directly as a catalyst or may be adsorbed onto a support such as carbon powder. In the latter case, the sol-gel derived catalyst may be mixed with carbon powder such as Vulcan XC72Râ [symbol] and refluxed with stirring, or simply allowed to stand for a period of time. The impregnated carbon powder may then be separated by filtration. Alternatively, the catalyst may be applied directly to the carbon powder and allowed to evaporate.

If the catalyst is loaded onto a carbon powder, reduction of the powder particle size may result in increased catalytic activity, based on the increased surface area of the catalyst support. Therefore, the carbon powder may be ground with a mortar and pestle, or cryoground under liquid nitrogen, or sonicated in ethanol to reduce particle size. Other known methods of reducing the powder particle size may be effective.

The catalyst, whether adsorbed on a carbon powder support or not, may be heat treated in an inert atmosphere such as nitrogen or argon. Preferably, the catalyst is heated to about 300Â°C. to about 1000Â° C. and more preferably, the catalyst is heated to about 700Â° C. to about 900Â° C. It is preferred that the inert atmosphere include a very small amount of oxygen to prevent reduction of the metal during heat treatment. Too much oxygen will result in excessive oxidation of the catalyst and carbon support less than about 1% and as little as 0.25% may have the desired anti-reductive effect. It is not known what physical or chemical changes occur during heat treatment, however, it is apparent that heat treatment does improve the activity and possibly the stability of the catalyst.

In use, the carbon powder loaded with the catalyst of the present solution may be applied to a fuel cell electrode with a Nafionâ [symbol] binder solution, as is well known in the art.

In an alternative embodiment, the catalyst may be prepared using sodium ethoxide. A transition metal nitrogen carbon ligand is added to an alcohol and refluxed with sodium ethoxide until dissolved. In one embodiment, the metal ligand salt is cis or trans-cobalt ethylene diamine dichloride or cis-cobalt phenylene diamine dichloride. The alcohol may be any monoalcohol, preferably having from 1 to 5 carbon atoms. More preferred alcohols have from 1 to 3 carbon atoms and therefore include methanol, ethanol, propanol, isopropanol and mixtures thereof. Any precipitate which may form may be removed by filtration and the remaining alcoholic solution, which contains the catalyst of the present invention, saved. Both cis- and trans-configurations of cobalt ethylene diamine dichloride [Co(En)₂Cl₂] may be used while a phenylene diamine may exist only in a cis configuration. Although the trans-isomer is predicted to be the better catalyst as it will have a square planar arrangement, which resembles the Co porphryin structure of known catalytic ability, this has not been borne out in practice. The catalysts prepared by this method may perform better in alkaline solution than in acidic solution. Therefore, these catalysts may not be suitable for use in PEM fuel cells.

In another alternative embodiment, a nitrogen-carbon ligand as described herein may be added to an aqueous cobalt solution and the resulting solution evaporated to form a gel or aerogel. The metal may preferably comprise cobalt. The cobalt solution may be formed by dissolving cobalt chloride or cobalt nitrate, or another suitable cobalt salt, in water. The resulting gel may be dissolved in water to form a solution of the catalyst which may be adsorbed onto carbon powder or another suitable support. The catalysts prepared by this method may perform better in alkaline solution than in acidic solution. Therefore, these catalysts may not be suitable for use PEM fuel cells.

### EXAMPLES

The examples below are carried out using standard techniques, which are well known and routine to those skilled in the art, except where otherwise described in detail. These examples- are intended to be illustrative, but not limiting, of the invention.

### Example 1

Catalyst Preparation using a Sol-Gel

4.4 g Co(NO₃)2Â·6H₂O or CoCl₂Â·6H₂O was dissolved in 15 mL absolute ethanol and refluxed (74Â° C.) for 6 hours followed by 18 hours of stirring at room temperature. 15 mL ethyl acetate and 1000 ppm non-ionic surfactant were added to create a ready to use 0.5 M sol. The solution is then brought back to reflux and between about 2 to about 3 molar equivalents of ethylene diamine diluted in 1:1 ethanol:ethyl acetate (v:v) was added dropwise over 1 to 5 days to the refluxing stirring solution. The resulting sol-gel derived catalyst solution was allowed to cool to room temperature and saved.

In a similar method, an alternative sol-gel derived catalyst was prepared using 2 to 3 molar equivalents of 1,2 phenylene diamine diluted in ethanol:ethyl acetate, added dropwise over 2 to 3 days to the refluxing stirring solution.

### Example 2

Catalyst Preparation using cobalt ethylene diamine dichloride (both cis and trans)

Cis- and trans-Co(En)₂Cl₂ were separately reacted with two equivalents of NaOEt (OK abbreviation?) in ethanol. Neither the green trans-Co(En)₂Cl₂ or the purple cis-Co(En)₂Cl₂ were soluble in ethanol, so it was added as a solid, along with the NaOEt. After refluxing for 12 hours and stirring for 18 hours at room temperature, a red solution and a brownish precipitate were obtained. The supernatant was recovered by filtration and saved.

### Example 3

Catalyst Preparation using a cobalt salt Solution

One molar equivalent of ethylene diamine was added over 2 hours to a stirred aqueous solution of 0.5 M Co(NO₃)₂. Evaporation of the solution gave a red glassy gel. The gel was redissolved in distilled water to provide a catalyst solution.

### Example 4

Adsorption of Catalyst onto Carbon

A catalyst solution or sol-gel derived catalyst solution was mixed with carbon powder (Vulcan SC72Râ) and refluxed together in ethanol for 2 to 4 hours, and then stirred overnight at room temperature. The solution was filtered and the carbon powder rinsed with ethanol. The powder was dried under vacuum before testing or use.

In an alternative method, the catalyst solution was poured over the carbon powder and allowed to evaporate to a sticky gel-like consistency. Because of the sol-gel properties of the catalyst solution, the sticky gel would not dry further.

### Example 5

Heat Treatment

Catalyst adsorbed carbon powder was heated under a flow of nitrogen gas for at least one hour and up to 2 hours. Various samples of catalyst were heated to temperatures ranging from 500Â° to about 900Â° C. An amount of air, less than 1.0%, was provided to some samples.

### Example 6

Tests for Catalytic Activity

Catalyst was prepared in accordance with the examples above were adsorbed onto carbon powder and heat-treated as described above. The catalyst was mixed with a 1 % solution of Nafionâ (diluted with ethanol or methanol) to give 20 mg of catalyst in 1 mL of solution. The catalyst solution was then sonicated for 15 minutes to improve dispersion and a measured volume applied to the surface of a glassy carbon rotating disc electrode (RDE) or a platinum ring, glassy carbon disc electrode (RRDE). The catalyst was dried either by air drying for 15 min to 1 hr, furnace drying at 175Â° C. for 15 minutes, or heat gun drying for 30 sec to 2 minutes. The final catalyst loading was 0.1 to 1 mg/cm2, depending on the experiment. The electrode was immersed in nitrogen purged 0.5 M sulphuric acid solution to measure the baseline electrochemical signal by cyclic voltametry (CV) and then the solution was saturated with air or oxygen to measure the oxygen reduction current at rotation rates from 0 to 2000 rpm by CV. The difference in current between the two CVs was taken as the oxygen reduction current.

A. Effect of Solution Temperature on Catalyst Activity

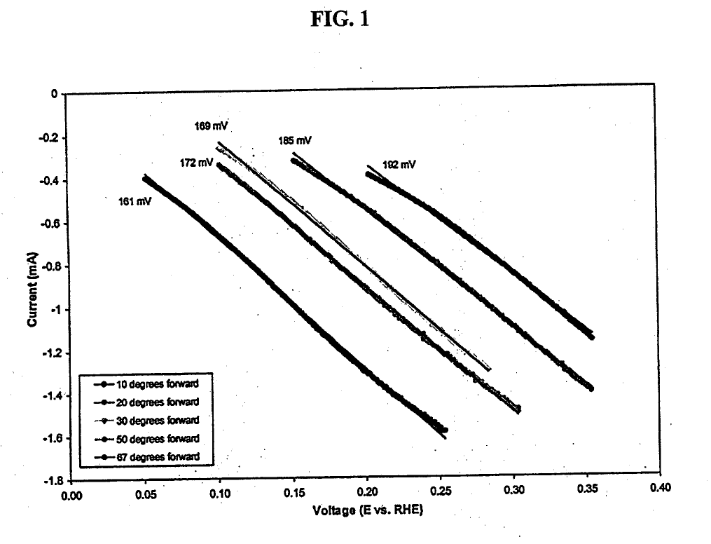

As seen in FIG. 1, catalytic activity increased with increased sulphuric acid solution temperature.

B. Effect of Heat Treatment on Catalyst Activity

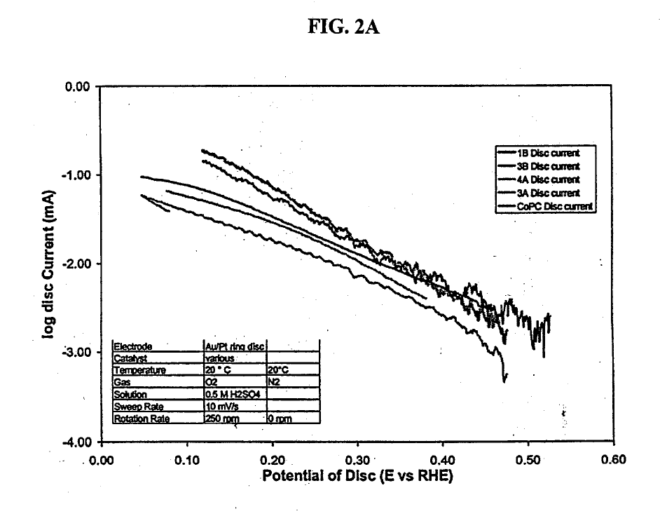

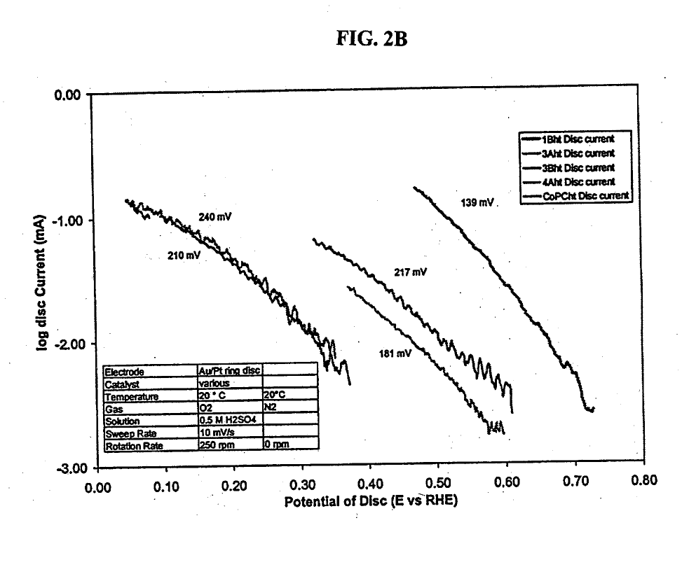

Catalyst was heat treated at various temperatures ranging from 500Â° C. to 900Â° C. and compared to catalyst samples which were not heat treated. As shown by comparing FIG. 2A (non-heat treated) with FIG. 2B (heat-treated), those catalysts which were heat treated showed significantly greater activity.

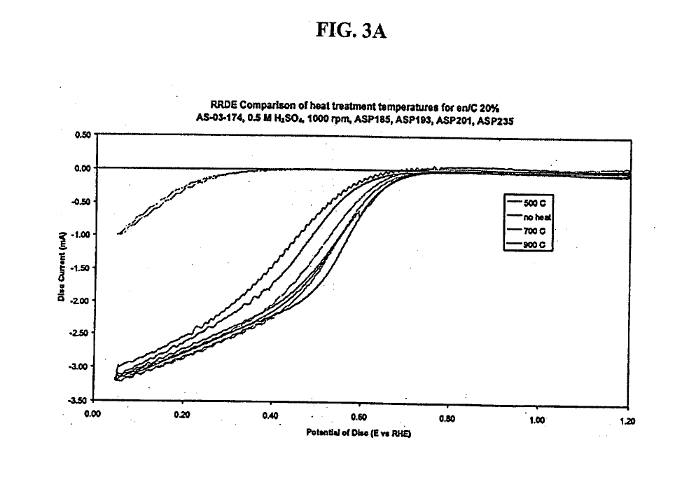

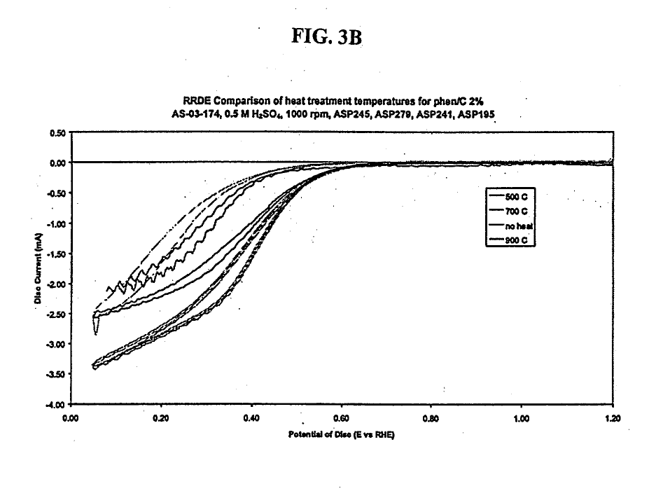

FIG. 3A shows catalytic activity for samples heated at 500Â° C., 700Â° C. and 900Â° C. for ethylene diamine catalysts, while FIG. 3B shows catalytic activity for samples heated at 500Â° C., 700Â° C. and 900Â° C. for phenylene diamine catalysts. Catalyst activity was best for those samples including ethylene diamine heated at 700Â° C. For those catalysts including phenylene diamine as the nitrogen-carbon ligand, catalyst activity was best for those samples heated at 900Â° C.

C. Effect of Ligand:Metal Ratio

Various molar ratios of the nitrogen-carbon ligand to metal were tested and the optimum ratio was found to be 2:1, which corresponds to a nitrogen:metal ratio of 4:1. This optimum ratio may correspond to the 4:1 ratio found in metal porphyrin materials. This result may indicate that virtually all of the ligand is complexed with the Co atoms, and no free ligand is left in solution. Adding additional ligand causes the catalyst to show decreased activity, which may be the result of the ligand continuing to bind to Co atoms and blocking oxygen binding sites.

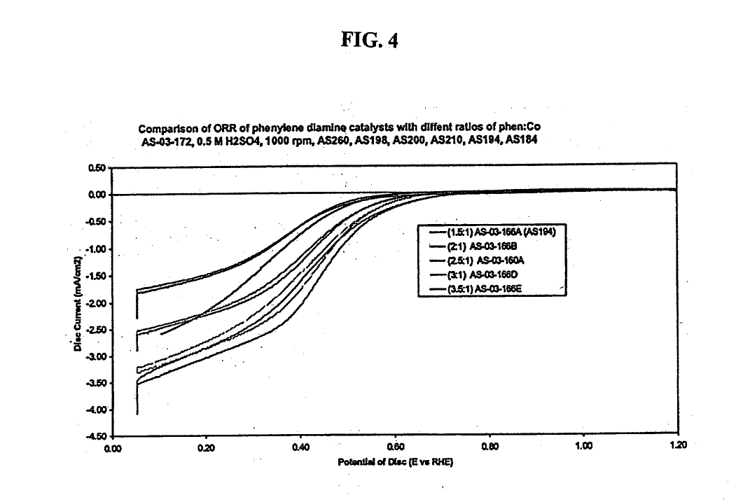

FIG. 4 shows a comparison of catalyst activity for a cobalt phenylene diamine catalyst at ligand:metal ratios of 1.5:1, 2:1, 2.5:1, 3:1, and 3.5:1.

D. Effect of Catalyst Loading.

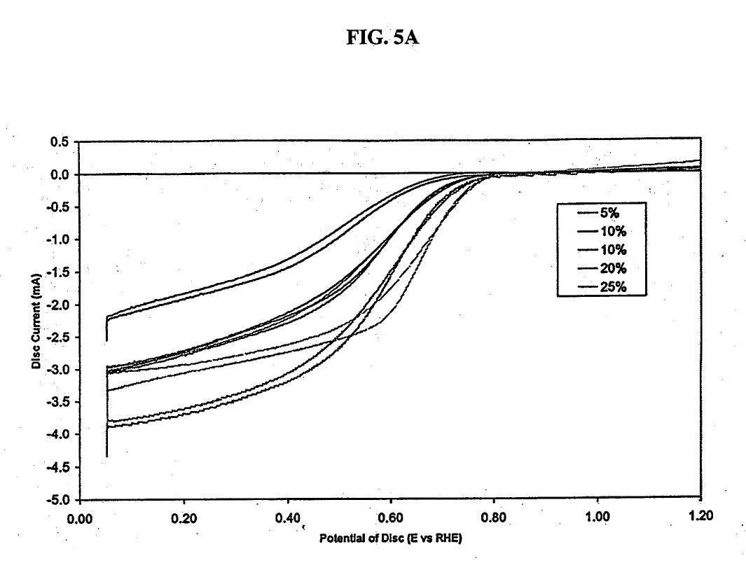

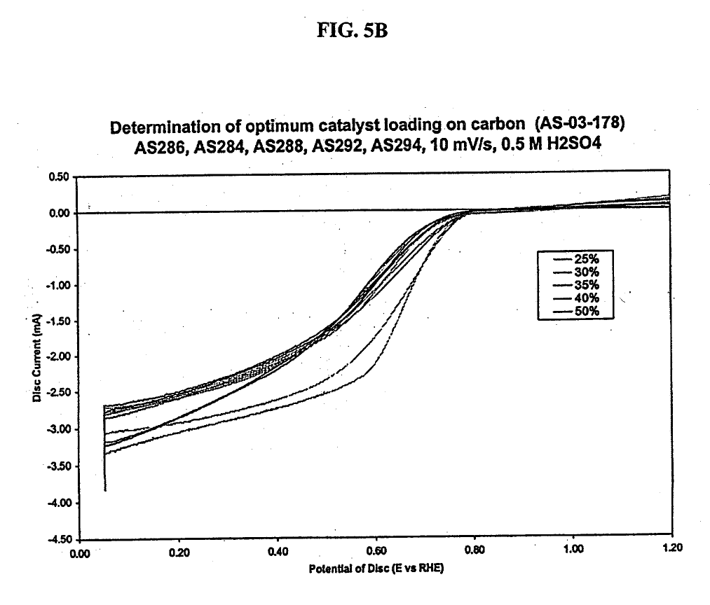

The catalyst was loaded onto the carbon powder in a range from 2% to 50% (by weight of Co). It was found that catalyst activity rises with catalyst loading to a peak corresponding to 25% loading, after which no appreciable gains are measured with greater loading, as seen in FIGS. 5A and 5B.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A method of forming a catalyst comprising the step of reacting a transition metal with a nitrogen-carbon ligand.

2. The method of claim 1 wherein the transition metal is provided as a solution or a sol-gel and is heated with the nitrogen carbon ligand in an alcohol.

3. The method of claim 1 wherein the transition metal is selected from the group consisting of cobalt, iron, nickel, vanadium, manganese, chromium, ruthenium, rhodium, iridium, osmium, rhenium, molybdenum, tungsten or mixtures thereof.

4. The method of claim 3 wherein the transition metal comprises cobalt.

5. The method of claim 4 wherein the sol-gel is prepared by dissolving and optionally refluxing a cobalt salt in a monohydric alcohol having from 1 to 5 carbon atoms.

6. The method of claim 1 wherein the nitrogen-carbon ligand comprises a N—(C)ₓ—N portion wherein x is 1, 2 or 3.

7. The method of claim 6 wherein x is 2.

8. The method of claim 7 wherein the nitrogen-carbon ligand is selected from the group consisting of ethylene diamine, 1,2 phenylene diamine, difluoro-1,2 phenylene diamine, trifluoro-1,2 phenylene diamine, ethene-1,2-diamine, butane-2,3 diamine, and 2,3-diamino-succinic acid, or mixtures thereof.

9. The method of claim 7 further comprising the step of adsorbing the catalyst sol-gel derived catalyst onto a physical support.

10. The method of claim 8 wherein the physical support comprises carbon powder.

11. The method of claim 9 further comprising the step of heating the catalyst to a temperature between about 300Â° C. and 1000Â° C. under an inert gas.

12. The method of claim 10 wherein the catalyst is heated to a temperature between about 700Â° C. and 900Â° C. under an inert gas containing less than about 1% oxygen.

13. The method of claim 10 further comprising the step of reducing the particle size of the carbon powder.

14. The method of claim 13 wherein the particle reduction step comprise a method selected from the group consisting of: grinding the carbon powder, cryogrinding the carbon powder under liquid nitrogen, and sonicating the carbon powder.

15. An oxygen reduction catalyst produced from the method of any one of claims 1 to 14.

16. An oxygen reduction catalyst comprising a coordination complex of a transition metal and a nitrogen-carbon ligand.

17. The catalyst of claim 16 wherein the transition metal is selected from the group consisting of cobalt, iron, nickel, vanadium, manganese, chromium, ruthenium, rhodium, iridium, osmium, rhenium, molybdenum, tungsten or mixtures thereof.

18. The catalyst of claim 17 wherein the nitrogen-carbon ligand comprises a N—(C)ₓ—N portion wherein x is 1, 2 or 3.

19. The catalyst of claim 18 wherein the nitrogen-carbon ligand is selected from the group consisting of ethylene diamine and 1,2 phenylene diamine, difluoro-1,2 phenylene diamine, trifluoro-1,2 phenylene diamine, ethene-1,2-diamine, butane-2,3 diamine, and 2,3-diamino-succinic acid, or mixtures thereof.

20. The catalyst of claim 19 further comprising a carbon powder support.

21. The catalyst of claim 20 which has been heat treated.

22. A method of forming a catalyst comprising the step of contacting cobalt nitrogen-carbon ligand salt with sodium ethoxide.

23. The method of claim 22 wherein the cobalt nitrogen-carbon ligand salt is Co(R)₂Cl₂ wherein R is ethylene diamine or 1,2 phenylene diamine.

24. The method of claim 23 wherein R is ethylene diamine and the cobalt nitrogen ligand salt is cis or trans.

25. The method of claim 24 wherein the sodium ethoxide and cobalt nitrogen-carbon ligand salt are refluxed in an alcohol.

26. A method of forming a catalyst comprising the steps of contacting a nitrogen-carbon ligand with cobalt ions in an aqueous solution and evaporating the solution to a gel.

27. The method of claim 26 wherein the nitrogen-carbon ligand comprises a N—(C)ₓ—N portion wherein x is 1, 2 or 3.

28. The method of claim 27 wherein the nitrogen carbon ligand is selected from the group consisting of ethylene diamine, 1,2 phenylene, difluoro-1,2 phenylene diamine, trifluoro-1,2 phenylene diamine, ethene-1,2-diamine, butane-2,3 diamine, and 2,3-diamino-succinic acid, or mixtures thereof.
